(19) United States
(12) Patent Application Publication
(10) Pub. No.: US 2016/0008780 A1
(43) Pub. Date: Jan. 14, 2016

(54) COLOR DETERMINATION FOR PHOTOPOLYMER MIXTURES IN ADDITIVE MANUFACTURING

(71) Applicant: MadeSolid, Inc., Emeryville, CA (US)

(72) Inventors: Lance Robert Pickens, Emeryville, CA (US); Brian Martinez, Emeryville, CA (US)

(21) Appl. No.: 14/328,677

(22) Filed: Jul. 10, 2014

(51) Int. Cl. B01F 15/00; G01N 21/17; G01N 21/25

(52) U.S. Cl. CPC B01F 15/00123; G01N 21/251; G01N 21/17

(57) ABSTRACT

The present disclosure relates to a system configured to determine an amount of color dye and/or pigment to add to a photopolymer mixture to produce an object of desired color after additive manufacturing. The system may comprise one or more of an additive manufacturing device, a color dispensing device, a physical computer processor, a user interface, electronic storage, external resources, and/or other components. The system is configured such that the color of a final object after additive manufacturing is controlled based on the light absorbance characteristics of the photopolymer, and/or other characteristics. Because of this, the final color of the object formed via additive manufacturing closely matches a target color specified by a user.

### FIELD

This disclosure relates to a system and method for determining an amount of color dye and/or pigment to add to a photopolymer mixture to produce an object of desired color after additive manufacturing.

### BACKGROUND

Additive manufacturing is well known. Additive manufacturing is known to include a layer by layer three dimensional object formation process wherein exposure to ultraviolet (UV) light cures (solidifies) a polymer resin and adheres the cured polymer resin to a previously solidified layer below. Typically, the color of a photopolymer used for additive manufacturing is determined by manually controlling a weight of colored dye as a percentage of the final weight of the photopolymer. The color of the final object after additive manufacturing is not controlled based on the light absorbance characteristics of the photopolymer and/or the colored dye. Because of this, the final color of the object formed via additive manufacturing often does not perfectly match a target color specified by a user.

### SUMMARY

One aspect of the disclosure relates to a system configured to determine an amount of color dye and/or pigment to add to a photopolymer mixture to produce an object of desired color after additive manufacturing. The system may comprise one or more of an additive manufacturing device, a color dispensing device, a physical computer processor, a user interface, electronic storage, external resources, and/or other components. The system may be configured such that the color of a final object after additive manufacturing is controlled based on the light absorbance characteristics of the photopolymer and/or the dyes/pigments and/or other material properties of the photopolymer and/or the dyes/pigments. Because of this, the final color of the object formed via additive manufacturing closely matches a target color specified by a user.

The additive manufacturing device may be configured to produce polymer objects by additive manufacturing. The additive manufacturing device may perform a layer by layer three dimensional object formation process wherein exposure to ultraviolet (UV) light cures (solidifies) a photopolymer resin and adheres the cured photopolymer resin to a previously solidified layer below.

The color dispensing device may be configured to dispense amounts of one or more individual pigments of different colors into the photopolymer mixture before solidification during additive manufacturing. The pigment dispenser may be controlled by the processor and/or other controllers.

The processor may be configured to execute computer program components. The computer program components may include an interface component, a color component, a parameter component, a quantity component, a control component, and/or other components. The processor may communicate wirelessly and/or via wires with the user interface, the additive manufacturing device, the color dispensing device, electronic storage, external resources, and/or other components of the system.

The interface component may be configured to effectuate presentation of a graphical user interface to a user. The graphical user interface may be presented via the user interface, a computing device associated with an individual user (e.g., a desktop computer, a laptop computer, a tablet computer, a smartphone, etc.), and/or other interfaces, for example. The graphical user interface may be configured to facilitate entry and/or selection of information from a user, display information to the user, and/or function in other ways. The graphical user interface may include one or more views configured to facilitate entry and/or selection of color information, material property parameter information, additive manufacturing process parameter information, and/or other information. The color information may indicate a desired/target object color for the object after additive manufacturing and/or other information. Entering and/or selecting color information may include uploading RGB (red green blue) and/or CMYK (cyan magenta yellow black) color codes, for example.

The color component may be configured to obtain the color information. The color component may be configured to obtain the color information via the graphical user interface, for example. The color information may include information related to one or more pigments and/or dyes of different colors that may be added to the photopolymer mixture. The one or more individual pigments and/or dyes of different colors may include one or more of a black pigment and/or dye, a cyan pigment and/or dye, a yellow pigment and/or dye, a magenta pigment and/or dye, a white pigment and/or dye, a red pigment and/or dye, a green pigment and/or dye, a blue pigment and/or dye, and/or other pigments and/or dyes.

The parameter component may be configured to obtain one or more material property parameters of the photopolymer mixture, one or more material property parameters of one or more individual dyes/pigments of different colors, one or more process parameters of the additive manufacturing process, and/or other parameters. In some implementations, the parameter component may be configured to determine the one or more material property parameters of the photopolymer mixture and/or the pigments and/or dyes, the process parameters, and/or other parameters based on the information received via the graphical user interface. In some implementations, parameter component 54 may be configured to determine parameters based on information stored in one or more external databases. Such databases may be part of electronic storage, the external resources, and/or other electronic storage devices. For example, responsive to a user specifying one or more components of the photopolymer mixture via the graphical user interface, the parameter component may determine one or more of the material property parameters of those components based on material property information for those components stored in a an external material property database (e.g., in external resources, in electronic storage, etc.).

The quantity component may be configured to determine amounts of the one or more individual pigments and/or dyes of different colors to add to the photopolymer mixture. The quantity component may determine the amounts of the one or more individual pigments and/or dyes such that the object has the desired color after additive manufacturing. The determination may be based on the color information, the material property parameters, the process parameters, and/or other information. In some implementations, the quantity component may be configured to determine amounts of the one or more individual pigments and/or dyes of different colors to add to the photopolymer mixture based on a predetermined color algorithm. The predetermined color algorithm may be determined at manufacture, uploaded by a user via user interface, and/or be determined in other ways. Inputs to the color algorithm may include one or more material property parameters of the photopolymer and/or the pigments and/or dyes, one or more additive manufacturing process parameters, and/or other parameters.

The control component may be configured to control the color dispensing device to dispense the amounts of the one or more individual pigments and/or dyes of different colors determined by the quantity component into the photopolymer mixture. In some implementations, the control component may be configured to control the additive manufacturing device to mix the photopolymer/color dye and/or pigment mixture until the color dye and/or pigment is substantially evenly distributed throughout the photopolymer mixture and ready for additive manufacturing.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to determine an amount of color dye and/or pigment to add to a photopolymer mixture to produce an object of desired color after additive manufacturing.

FIG. 2A illustrates a color dispensing device and a mixer.

FIG. 2B is a second illustration of a color dispensing device and a mixer.

FIG. 2C is an illustration of a view of a graphical user interface presented to a user.

FIG. 3 illustrates a method for determining an amount of color dye and/or pigment to add to a photopolymer mixture to produce an object of desired color after additive manufacturing.

### DETAILED DESCRIPTION

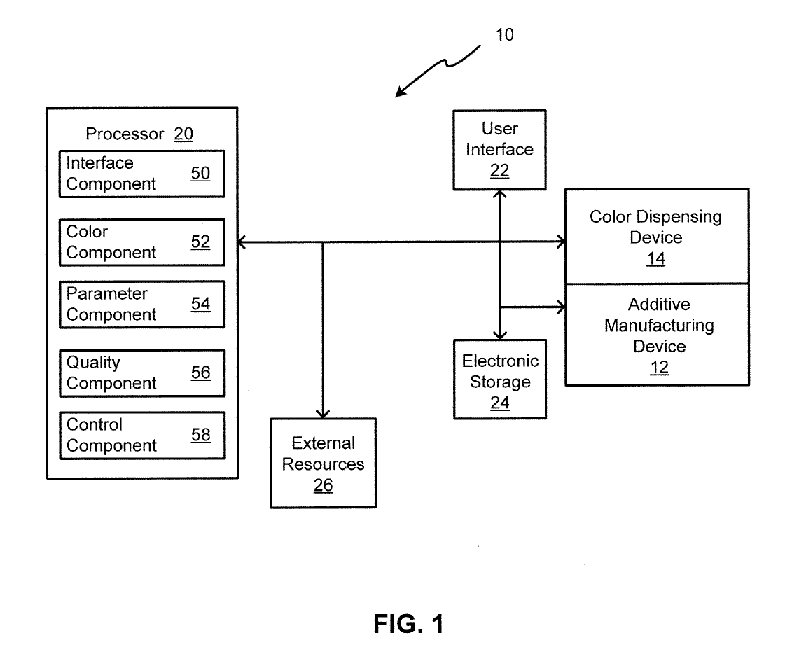

FIG. 1 illustrates a system 10 configured to determine an amount of color dye and/or pigment to add to a photopolymer mixture to produce an object of desired color after additive manufacturing. System 10 may comprise one or more of an additive manufacturing device 12, a color dispensing device 14, a physical computer processor 20, a user interface 22, electronic storage 24, external resources 26, and/or other components. System 10 may be configured such that the color of a final object after additive manufacturing is controlled based on the light absorbance characteristics of the photopolymer and/or the dyes/pigments and/or other material properties of the photopolymer and/or the dyes/pigments. Because of this, the final color of the object formed via additive manufacturing closely matches a target color specified by a user.

Additive manufacturing device 12 may be configured to produce polymer objects by additive manufacturing. Additive manufacturing device 12 may perform a layer by layer three dimensional object formation process wherein exposure to ultraviolet (UV) light cures (solidifies) a photopolymer resin and adheres the cured photopolymer resin to a previously solidified layer below. Additive manufacturing device 12 may include one or more of a motor, a valve, a piston, a stage and/or tray, electronic control circuitry, wiring, a housing, a frame, a light source, a scanner, a mixer including a reservoir configured to hold a photopolymer mixture, a mixing blade, a display, a control pad, a heater, a sensor, and/or other components that allow additive manufacturing device 12 to function as described herein. In some implementations, additive manufacturing device 12 may be configured to communicate with color dispensing device 14, processor 20, user interface 22, external resources 26, electronic storage 24, and/or other components of system 10 wirelessly (e.g., via a wireless communication network such as the internet) and/or via wires. For example, additive manufacturing device 12 may include a transceiver and/or other communication components configured to facilitate wireless communication between additive manufacturing device 12 and other components of system 10.

Color dispensing device 14 may be configured to dispense amounts of one or more individual pigments of different colors into the photopolymer mixture before solidification during additive manufacturing such that the object has the desired color after additive manufacturing. The pigment dispenser may be controlled by processor 20 and/or other controllers. Color dispensing device 14 may include one or more reservoirs for holding pigments and/or dyes of different colors, valves, nozzles, hoses, electronic control components, wiring motors, heaters, sensors, a housing, and/or other components that allow color dispensing device 14 to function as described herein. In some implementations, color dispensing device 14 may be configured to communicate with additive manufacturing device 14, processor 20, user interface 22, external resources 26, electronic storage 24, and/or other components of system 10 wirelessly (e.g., via a wireless communication network such as the internet) and/or via wires. For example, additive manufacturing device 12 may include a transceiver and/or other communication components configured to facilitate wireless communication between color dispensing device 14 and other components of system 10.

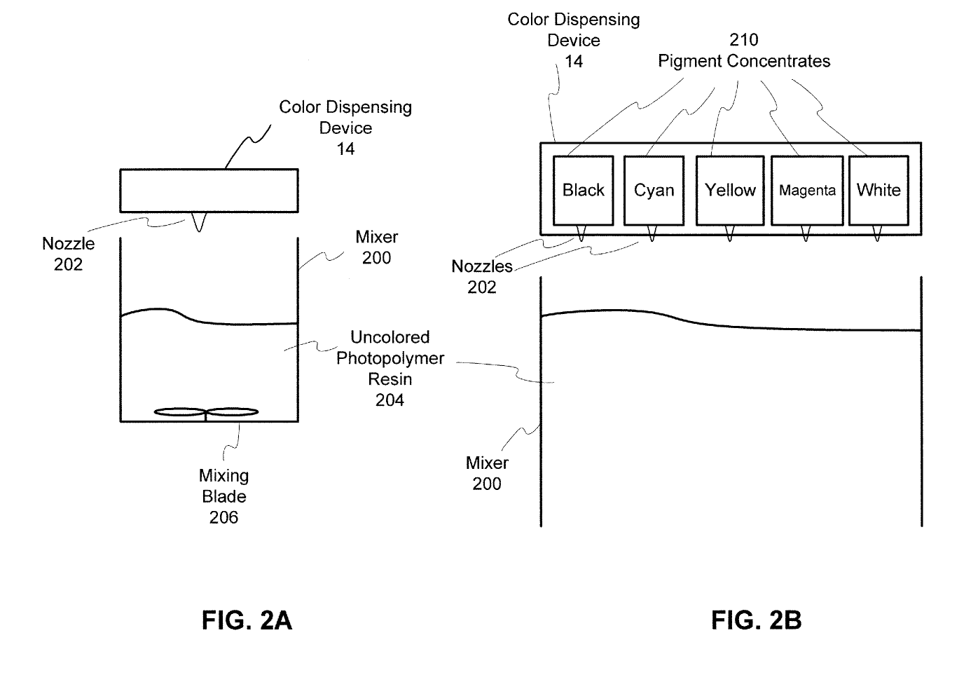

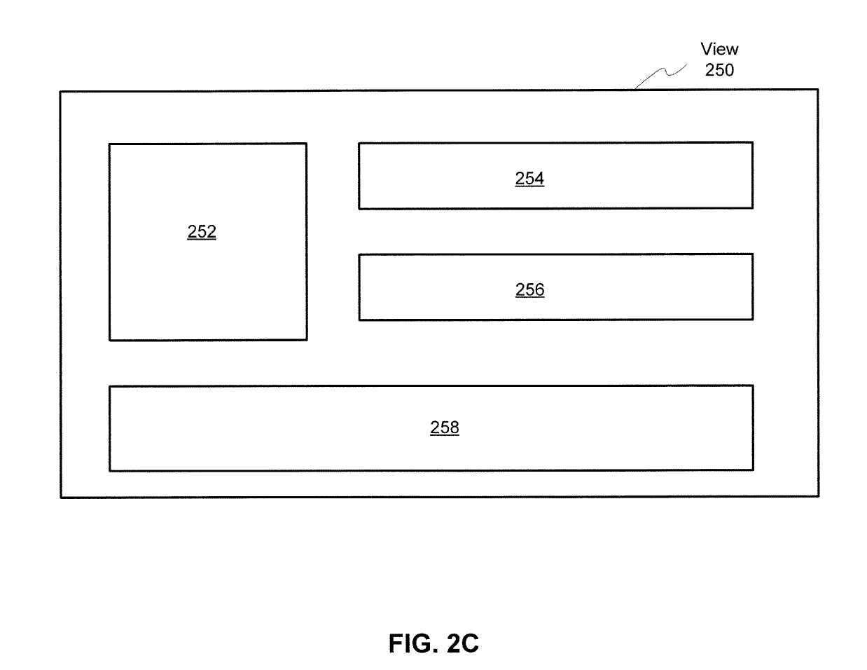

By way of a non-limiting example, FIG. 2A and FIG. 2B illustrate color dispensing device 14 positioned over a mixer 200 that is part of additive manufacturing device 12 (FIG. 1). Dye and/or pigment 210 (e.g., pigment concentrates) may be dispensed through nozzles 202 into the uncolored (e.g., a white and/or slightly yellow base) photopolymer 204. The color may be mixed in by mixing blade 206 and or other mixing techniques.

Returning to FIG. 1, processor 20 may be configured to execute computer program components. The computer program components may be configured to enable an expert and/or user associated with system 10 to interface with user interface 22, color dispensing device 14, additive manufacturing device 12, electronic storage 24, and/or external resources 26, and/or provide other functionality attributed herein to processor 20. The computer program components may include an interface component 50, a color component 52, a parameter component 54, a quantity component 56, a control component 58, and/or other components. Processor 20 may communicate wirelessly and/or via wires with user interface 22, additive manufacturing device 12, color dispensing device 14, electronic storage 24, external resources 26, and/or other components of system 10.

Interface component 50 may be configured to effectuate presentation of a graphical user interface to a user. The graphical user interface may be presented via user interface 22, a computing device associated with an individual user (e.g., a desktop computer, a laptop computer, a tablet computer, a smartphone, etc.), and/or other interfaces, for example. The graphical user interface may be configured to facilitate entry and/or selection of information from a user, display information to the user, and/or function in other ways. The graphical user interface may include one or more views configured to facilitate entry and/or selection of color information and/or other information. The color information may indicate a desired/target object color for the object after additive manufacturing and/or other information. For example, a user may select a specific color presented as part of a palette of colors in one or more views of the graphical user interface. As another example, a user may enter an electronic color code via the graphical user interface that specifies the desired object color. As a third example, a user may upload an electronic color code via a computing device associated with the individual user.

In some implementations, the one or more views of the graphical user interface may facilitate entry and/or selection of information related to a composition of the photopolymer mixture, information related to the additive manufacturing process, and/or other information. The photopolymer mixture may be composed of one or more photopolymers and/or other components. The user may specify the mixture composition via the graphical user interface. In some implementations, interface component 50 may cause the graphical user interface to present (e.g., a drop down list) one or more material choices to a user for selection.

In some implementations, a user may enter and/or select information related to the additive manufacturing process. The information related to the additive manufacturing process may include a type of additive manufacturing; the additive manufacturing equipment; information related to a wavelength of light used during additive manufacturing; distances, rates, times, temperatures, layer thicknesses, and/or environmental parameters used during additive manufacturing; and/or other process parameters.

By way of a non-limiting example, FIG. 2C illustrates a view 250 of the graphical user interface configured to facilitate entry and/or selection of color information, material property information, process parameter information, and/or other information. View 250 includes a color field 252, a material field 254, a process field 256, and an algorithm field 258. A user may enter and/or select color information via color field 252. Entering and/or selecting color information may include uploading RGB (red green blue) and/or CMYK (cyan magenta yellow black) color codes for example. Material field 254 may facilitate entry and/or selection of the type of photopolymer and/or the components of a photopolymer mixture. For example, a user may specify an individual photopolymer that will be used to form the additive manufacturing object via field 254. Process field may facilitate entry and/or selection of a specific additive manufacturing process and/or specific manufacturing process parameters (e.g., a wavelength of light used to cure the photopolymer during additive manufacturing.) A user may utilize algorithm field 258 to upload and/or adjust a color algorithm that determines an amount of individual dyes and/or pigments of different colors to add to the photopolymer mixture (described below).

Fields 252-258 may include drop down menus, sliders, graphical buttons and/or other means for a user to enter and/or select information via view 250. The number of fields and/or the functionality of the fields described in view 250 is not intended to be limiting. View 250 may include any number and/or types of useful fields that are displayed to a user in order to facilitate entry and/or selection of color information, material property information, process parameter information, and/or other information.

Returning to FIG. 1, color component 52 may be configured to obtain the color information. Color component 52 may be configured to obtain the color information via the graphical user interface, for example. The color information may include information related to one or more pigments and/or dyes of different colors that may be added to the photopolymer mixture. As described above, the one or more individual pigments and/or dyes of different colors may include one or more of a black pigment and/or dye, a cyan pigment and/or dye, a yellow pigment and/or dye, a magenta pigment and/or dye, a white pigment and/or dye, a red pigment and/or dye, a green pigment and/or dye, a blue pigment and/or dye, and/or other pigments and/or dyes.

In some implementations, the color information may include one or more of an RGB (red green blue) color code, a CMYK (cyan magenta yellow black) color code and/or other color codes. The color codes may be specified by a user in via the user interface, uploaded by a user from an external computing device (e.g., a desktop computer, a laptop computer, a tablet computer, a smartphone, etc.) via a wireless communication network, and/or communicated to color component 52 in other ways. In some implementations, color component 52 may be configured to determine a color code based on input from a user via the user interface. For example, a user may specify a color using the user interface by selecting a color from a CMYK color chart. Color component 52 may determine a color code based on the user's selection. In some implementations, color component 52 may determine the color code based on the user's selection and/or information stored in an external database (e.g., external resources 26). The external database may store color codes for individual color that may be selected by a user, for example.

Parameter component 54 may be configured to obtain one or more material property parameters of the photopolymer mixture, one or more material property parameters of one or more individual dyes/pigments of different colors, and/or other material property parameters. The material property parameters may indicate light absorbance characteristics of the photopolymer mixture, light absorbance characteristics of the one or more individual pigments of different colors, photo-initiator reactivity, an amount of monomer in the mixture, and/or other information. In some implementations, the photopolymer mixture may be comprised of one or more individual components mixed together. In some implementations, the material property parameters may indicate light absorbance characteristics and/or other properties of individual components of the photopolymer mixture.

In some implementations, parameter component 54 may be configured to determine the one or more material property parameters of the photopolymer mixture and/or the pigments and/or dyes based on the information related to the composition of the photopolymer mixture received via the graphical user interface and/or other information. In some implementations, parameter component 54 may be configured to determine the one or more material property parameters based on information stored in a material property database. Such a database may be part of electronic storage 24, external resources 26, and/or other electronic storage devices. For example, responsive to a user specifying one or more components of the photopolymer mixture via the graphical user interface, parameter component 54 may determine one or more of the material property parameters of those components based on material property information for those components stored in a an external material property database (e.g., external resources 26, in electronic storage 24, etc.). As another example, external resources 26 may include a database server configured to store material property parameters for common additive manufacturing materials. Responsive to a user specifying the photopolymer that is to be used to fabricate the additive manufacturing object, parameter component 54 may be configured to access the server and determine material property parameters for the selected photopolymer.

In some implementations, parameter component 54 may be configured to obtain one or more process parameters of the additive manufacturing process. In some implementations, parameter component 54 may be configured to obtain and/or determine the one or more process parameters of the additive manufacturing process based on the information related to the additive manufacturing process received via the graphical user interface. In some implementations, parameter component 54 may be configured such that obtaining one or more process parameters includes determining one or more process parameters based on information stored in an external database. For example, the type of additive manufacturing process may be input by a user via the graphical user interface, determined at manufacture, and/or determined in other ways. Parameter component 54 may obtain and/or determine process parameters based on the type of manufacturing process and information related to that particular manufacturing process stored in an external database (e.g., external resources 26). In some implementations, the one or more process parameters may include parameters related to the additive manufacturing equipment, a wavelength of light (e.g., ultraviolet) used during the additive manufacturing process, distances, rates, times, temperatures, layer thicknesses, and/or environmental parameters used during additive manufacturing, and/or other process parameters. In some implementations, parameter component 54 may be configured to obtain/determine process parameters based on direct entries and/or selections made by the user via the graphical user interface.

Quantity component 56 may be configured to determine amounts of the one or more individual pigments and/or dyes of different colors to add to the photopolymer mixture. Quantity component 56 may determine the amounts of the one or more individual pigments and/or dyes such that the object has the desired color after additive manufacturing. The determination may be based on the color information, the material property parameters, the process parameters, and/or other information. In some implementations, quantity component 56 may be configured to determine the amounts of the one or more individual pigments of different colors to add to the photopolymer mixture based on the light absorbance characteristics of the individual components of the photopolymer mixture, the light absorbance characteristics of the one or more individual dyes and/or pigments of different colors, and/or other information. For example, quantity component 56 may be configured to determine amounts of the one or more individual pigments and/or dyes based on light absorption patterns of individual dyes and/or pigments at various light wavelengths (e.g., determined by parameter component 54) in order to produce a final mixture that can be used in additive manufacturing at a wavelength selected by the user (e.g., via user interface 22).

In some implementations, quantity component 56 may be configured to determine amounts of the one or more individual pigments and/or dyes of different colors to add to the photopolymer mixture based on a predetermined color algorithm. The predetermined color algorithm may be determined at manufacture, uploaded by a user via user interface 22, and/or be determined in other ways. Inputs to the color algorithm may include one or more material property parameters of the photopolymer and/or the pigments and/or dyes, one or more additive manufacturing process parameters, and/or other parameters. The algorithm may be configured to output one or more quantities of one or more different colored dyes and/or pigments for adding to the photopolymer mixture. In some implementations, the color algorithm may be adjusted by a user. The color algorithm may be adjusted via user interface 22 and/or other computing devices configured to communicate with system 10, for example. A user may adjust the color algorithm so that one or more inputs are eliminated and/or one or more additional inputs are included when determining the amounts of the individual pigments and/or dyes to add to the photopolymer mixture.

Control component 58 may be configured to control color dispensing device 14 to dispense the amounts of the one or more individual pigments and/or dyes of different colors determined by quantity component 56 into the photopolymer mixture. Controlling color dispensing device 14 may include controlling one or more nozzles and/or valves of color dispensing device 14 to open and/or close to dispense a determined amount of dye and/or pigment. For example, responsive to a valve being opened by control component 58, gravity may cause color dye and/or pigment to fall into the photopolymer mixture until the valve is closed. In some implementations, control component 58 may be configured to control a pump included in color dispensing device 14 to pump a determined amount of dye and/or pigment into the photopolymer mixture. In some implementations, control component 58 may be configured to control additive manufacturing device 12 to mix the photopolymer/color dye and/or pigment mixture until the color dye and/or pigment is substantially evenly distributed throughout the photopolymer mixture and ready for additive manufacturing.

For example, as described above, FIG. 2A and FIG. 2B, illustrate color dispensing device 14 positioned over mixer 200 that is part of additive manufacturing device 12 (FIG. 1). Dye and/or pigment 210 (e.g., pigment concentrates) may be dispensed through nozzles 202 into the uncolored (e.g., a white and/or slightly yellow base) photopolymer 204. The color may be mixed in by mixing blade 206 and or other mixing techniques. In this example, control component 58 may be configured to control nozzles 202, mixing blade 206, and/or other components, for example.

In some implementations, system 10 may include one or more sensors (not shown) configured to generate output signals that convey information related to material properties of the photopolymer mixture, process parameters of the additive manufacturing process, and/or other information. For example, the one or more sensors may generate output signals that identify a type of material and/or materials that form the photopolymer mixture. The one or more sensors may generate output signals conveying information indicating a density, weight, specific gravity, and/or other properties of the photopolymer that may be used to identify the photopolymer. As another example, one or more sensors may generate output signals conveying information related to the additive manufacturing process. The sensors may generate output signals conveying information to a wavelength of light used to cure the photopolymer, environmental conditions, and/or other information. In some implementations, the information generated by the sensors may be used to identify the type of additive manufacturing process and/or previously not obtained and/or undetermined parameters (e.g., a processing detail not received via user interface 22 and/or not determined via external resources 26) of the additive manufacturing process. The sensors may be located in one or more locations throughout system 10. For example, the sensors may be located in and/or in communication with photopolymer resin 204 in mixer 200, within and/or in communication with color dispensing device 14, within and/or in communication with nozzles 202, and/or located in other locations.

Returning to FIG. 1, user interface 22 may be configured to provide an interface between system 10 and the user through which the user may provide information to and receive information from system 10. This enables data, cues, results, and/or instructions and any other communicable items, collectively referred to as “information,” to be communicated between the user and system 10.

By way of a non-limiting example, user interface 22 may be configured to receive entry and/or selection of color information (e.g., color codes) that indicates a desired object color for the object after additive manufacturing. Receiving entry and/or selection of color information may include a user typing information via a key pad and/or a keyboard, selecting (e.g., via a mouse and/or a touchscreen) information from a list of choices provided to the user, selecting an individual color on a color palette, uploading electronic color codes, and/or other entry and/or selection. In some implementations, user interface 22 and/or external resources 26 may be configured such that receiving entry and/or selection of the color information may include reading, scanning, and/or optically recognizing the color of another object that identifies a user's desired object color for the object after additive manufacturing. For example, external resources 26 may include an optical sensor controlled via user interface 22 configured to recognize a color of, and/or other identifying (e.g., a bar code that indicates an RGB and/or a CMYK color code) marks on, an object.

Examples of interface devices suitable for inclusion in user interface 22 include a touch screen, a keypad, touch sensitive and/or physical buttons, switches, a keyboard, knobs, levers, a display, speakers, a microphone, an indicator light, a printer, and/or other interface devices. In some implementations, user interface 22 includes a plurality of separate interfaces. In some implementations, user interface 22 includes at least one interface that is provided integrally with processor 20. In some implementations, user interface 22 may be included in a computing device (e.g., a desktop computer, a laptop computer, a tablet computer, a smartphone, etc.) associated with an individual user.

It is to be understood that other communication techniques, either hard-wired or wireless, are also contemplated by the present disclosure as user interface 22. For example, the present disclosure contemplates that user interface 22 may be integrated with a removable storage interface provided by electronic storage 22. In this example, information may be loaded into system 10 from removable storage (e.g., a smart card, a flash drive, a removable disk) that enables the user to customize the implementation of system 10. Other exemplary input devices and techniques adapted for use with system 10 as user interface 22 include, but are not limited to, an RS-232 port, RF link, an IR link, modem (telephone, cable or other). In short, any technique for communicating information with system 10 is contemplated by the present disclosure as user interface 22.

Electronic storage 24 may comprise electronic storage media that electronically stores information. The electronic storage media of electronic storage 24 may comprise one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 24 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 24 may store software algorithms (e.g., color mixture amount algorithms), information (e.g., material and/or process parameters) determined by processor 20, and/or other information that enables system 10 to function properly. Electronic storage 24 may be (in whole or in part) a separate component within system 10, or electronic storage 24 may be provided (in whole or in part) integrally with one or more other components of system 10 (e.g., processor 20).

External resources 26 may include sources of information (e.g., an electronic material property database, a process parameter database), one or more servers outside of system 10, a network (e.g., the internet), electronic storage, equipment related to Wi-Fi technology, equipment related to Bluetooth® technology, data entry devices, sensors, scanners, computing devices associated with individual users, and/or other resources. In some implementations, some or all of the functionality attributed herein to external resources 26 may be provided by resources included in system 10. External resources 26 may be configured to communicate with processor 20 and/or other components of system 10 via wired and/or wireless connections, via a network (e.g., a local area network and/or the internet), via cellular technology, via Wi-Fi technology, and/or via other resources. For example, parameter component 54 may access a material property parameter database that is part of external resources 26 via the internet. As another example, processor 20 may communicate with sensors configured to generate output signals conveying information related to the composition of the photopolymer mixture via a WI-FI connection, a removable wired connection (e.g., a USB connection), and/or other connections.

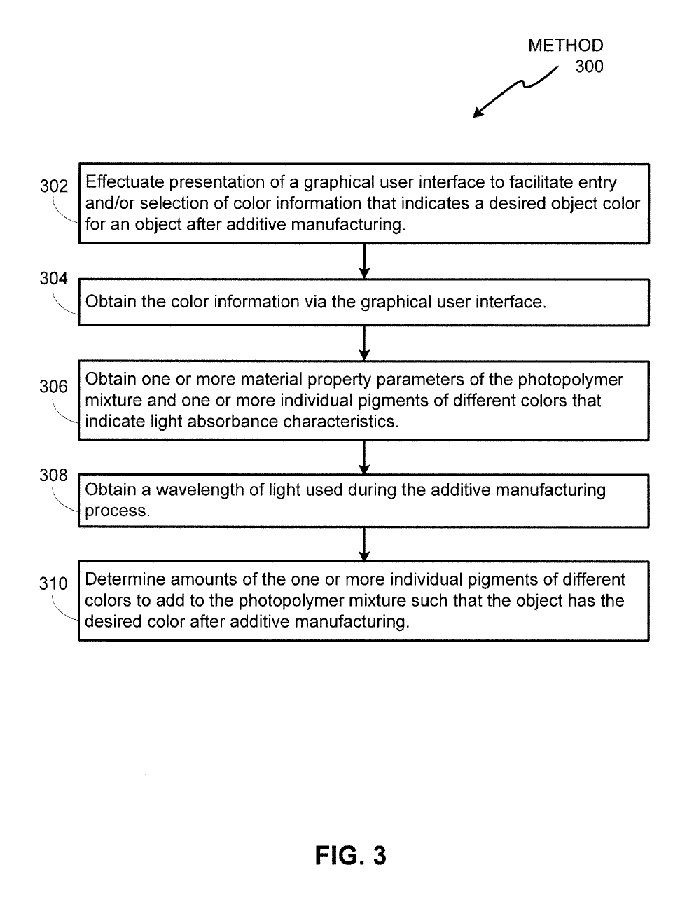

FIG. 3 illustrates a method 300 for determining an amount of color dye and/or pigment to add to a photopolymer mixture to produce an object of desired color after additive manufacturing. The operations of method 300 presented below are intended to be illustrative. In some implementations, method 300 may be accomplished with one or more additional operations not described, and/or without one or more of the operations discussed. Additionally, the order in which the operations of method 300 are respectively illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At an operation 302, presentation of a graphical user interface may be effectuated. The graphical user interface may be configured to facilitate entry and/or selection of information from a user and display information to the user. The graphical user interface may include one or more views configured to facilitate entry and/or selection of color information that indicates a desired object color for the object after additive manufacturing. Operation 302 may be performed by a computer processor component that is the same as or similar to interface component 50 (shown in FIG. 1 and described herein).

At an operation 304, the color information may be obtained via the graphical user interface. Operation 304 may be performed by a computer processor component the same as or similar to color component 52 (shown in FIG. 1 and described herein).

At an operation 306, one or more material property parameters of the photopolymer mixture and one or more individual dyes/pigments of different colors that indicate light absorbance characteristics may be obtained. The material property parameters may indicate light absorbance characteristics of the photopolymer mixture and/or the one or more individual dyes/pigments of different colors, for example. The one or more individual pigments of different colors may include one or more of a black pigment, a cyan pigment, a yellow pigment, a magenta pigment, a white pigment, a red pigment, a green pigment, or a blue pigment, for example. In some implementations, obtaining the one or more material property parameters of the photopolymer mixture and/or the individual pigments may include determining one or more material property parameters based on information stored in an external database. In some implementations, one or more material property parameters may be determined based on information entered and/or selected via the user interface. In some implementations, operation 306 may include determining individual components of a photopolymer mixture and then determining material properties of the individual components (the material properties indicating the light absorption characteristics of the individual components). Operation 306 may be performed by a computer processor component the same as or similar to parameter component 54 (shown in FIG. 1 and described herein).

At an operation 308, a wavelength of light used during the additive manufacturing process may be obtained. Operation 308 may include determining one or more other process parameters of the additive manufacturing process. For example, the one or more process parameters may include a wavelength of ultraviolet light used during the additive manufacturing process. In some implementations, obtaining one or more process parameters of the additive manufacturing process may include determining one or more process parameters of the additive manufacturing process based on information stored in an external database. In some implementations, one or more process parameters of the additive manufacturing process may be determined based on information entered and/or selected via the user interface. Operation 308 may be performed by a computer processor component that is the same as or similar to parameter component 54 (shown in FIG. 1 and described herein).

At an operation 310, amounts of the one or more individual dyes/pigments of different colors to add to the photopolymer mixture such that the object has the desired color after additive manufacturing may be determined. The determination may be based on the color information, the material property parameters, the process parameters, and/or other information. In some implementations, operation 310 may include dispensing (and/or controlling the dispensing of) the amounts of one or more individual pigments of different colors into the photopolymer mixture before solidification during additive manufacturing such that the object has the desired color after additive manufacturing. Operation 310 may be performed by a computer processor component that is the same as or similar to quantity component 56 and/or control component 58 (shown in FIG. 1 and described herein).

Returning to FIG. 1, processor 20 may be configured to provide information processing capabilities in system 10. As such, processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some implementations, processor 20 may comprise a plurality of processing units. These processing units may be physically located within the same device (e.g., a desktop computer, a laptop computer, a tablet computer, a smartphone, and/or other computing devices, within additive manufacturing device 12, within color dispensing device 14, etc.), or processor 20 may represent processing functionality of a plurality of devices operating in coordination (e.g., color dispensing device 14 and additive manufacturing device 12). Processor 20 may be configured to execute components 50, 52, 54, 56, and/or 58 by software; hardware; firmware; some combination of software, hardware, and/or firmware; and/or other mechanisms for configuring processing capabilities on processor 20.

It should be appreciated that although components 50, 52, 54, 56, and 58 are illustrated in FIG. 1 as being co-located within a single processing unit, in implementations in which processor 20 comprises multiple processing units, one or more of components 50, 52, 54, 56, and/or 58 may be located remotely from the other components (e.g., such as within color dispensing device 14). The description of the functionality provided by the different components 50, 52, 54, 56, and/or 58 described herein is for illustrative purposes, and is not intended to be limiting, as any of components 50, 52, 54, 56, and/or 58 may provide more or less functionality than is described. For example, one or more of components 50, 52, 54, 56, and/or 58 may be eliminated, and some or all of its functionality may be provided by other components 50, 52, 54, 56, and/or 58. As another example, processor 20 may be configured to execute one or more additional components that may perform some or all of the functionality attributed below to one of components 50, 52, 54, 56, and/or 58. In some implementations, one or more of components 50, 52, 54, 56, and/or 58 may be executed by a processor incorporated in color dispensing device 14, additive manufacturing device 12, external resources 26, and/or other components of system 10.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system configured to determine an amount of pigment to add to a photopolymer mixture to produce an object of desired color after additive manufacturing, the system comprising one or more physical computer processors configured by computer readable instructions to:
effectuate presentation of a graphical user interface configured to facilitate entry and/or selection of information from a user and display information to the user, the graphical user interface including one or more views configured to facilitate entry and/or selection of color information that indicates a desired object color for the object after additive manufacturing;
obtain the color information via the graphical user interface;
obtain one or more material property parameters of the photopolymer mixture and one or more individual pigments of different colors, the material property parameters indicating light absorbance characteristics of the photopolymer mixture and the one or more individual pigments of different colors;
obtain one or more process parameters of the additive manufacturing process, the one or more process parameters including a wavelength of light used during the additive manufacturing process; and
determine amounts of the one or more individual pigments of different colors to add to the photopolymer mixture such that the object has the desired color after additive manufacturing, the determination based on the color information, the material property parameters, and the process parameters.

2. The system of claim 1, wherein the one or more physical computer processors are further configured such that the one or more views of the graphical user interface facilitate entry and/or selection of one or more of information related to a composition of the photopolymer mixture or information related to the additive manufacturing process;
wherein the one or more physical computer processors are configured to determine the one or more material property parameters of the photopolymer mixture based on the information related to the composition of the photopolymer mixture received via the graphical user interface; and
wherein the one or more physical computer processors are configured to determine the one or more process parameters of the additive manufacturing process based on the information related to the additive manufacturing process received via the graphical user interface.

3. The system of claim 1, wherein the one or more physical computer processors are configured to obtain one or more material property parameters of one or more individual components of the photopolymer mixture.

4. The system of claim 3, wherein the one or more physical computer processors are configured such that the material property parameters indicate light absorbance characteristics of the individual components of the photopolymer mixture.

5. The system of claim 4, wherein the one or more physical computer processors are configured to determine the amounts of the one or more individual pigments of different colors to add to the photopolymer mixture based on the absorbance characteristics of the individual components of the photopolymer mixture and the one or more individual pigments of different colors.

6. The system of claim 1, further comprising a pigment dispenser configured to dispense the amounts of one or more individual pigments of different colors into the photopolymer mixture before solidification during additive manufacturing such that the object has the desired color after additive manufacturing, the pigment dispenser controlled by the one or more physical computer processors.

7. The system of claim 1, wherein the one or more physical computer processors are configured such that the one or more process parameters include a wavelength of ultraviolet light used during the additive manufacturing process.

8. The system of claim 1, wherein the one or more physical computer processors are configured such that the one or more individual pigments of different colors include one or more of a black pigment, a cyan pigment, a yellow pigment, a magenta pigment, a white pigment, a red pigment, a green pigment, or a blue pigment.

9. The system of claim 1, wherein the one or more physical computer processors are configured such that obtaining one or more material property parameters of the photopolymer mixture includes determining one or more material property parameters based on information stored in an external database.

10. The system of claim 1, wherein the one or more physical computer processors are configured such that the color information includes one or more of an RGB color code or a CMYK color code.

11. A method for determining an amount of pigment to add to a photopolymer mixture to produce an object of desired color after additive manufacturing, the method comprising:
effectuating presentation of a graphical user interface configured to facilitate entry and/or selection of information from a user and display information to the user, the graphical user interface including one or more views configured to facilitate entry and/or selection of color information that indicates a desired object color for the object after additive manufacturing;
obtaining the color information via the graphical user interface;
obtain one or more material property parameters of the photopolymer mixture and one or more individual pigments of different colors, the material property parameters indicating light absorbance characteristics of the photopolymer mixture and the one or more individual pigments of different colors;
obtaining one or more process parameters of the additive manufacturing process, the one or more process parameters including a wavelength of light used during the additive manufacturing process; and
determining amounts of the one or more individual pigments of different colors to add to the photopolymer mixture such that the object has the desired color after additive manufacturing, the determination based on the color information, the material property parameters, and the process parameters.

12. The method of claim 11, further comprising facilitating entry and/or selection of one or more of information related to a composition of the photopolymer mixture or information related to the additive manufacturing process;
determining the one or more material property parameters of the photopolymer mixture based on the information related to the composition of the photopolymer mixture received via the graphical user interface; and
determining the one or more process parameters of the additive manufacturing process based on the information related to the additive manufacturing process received via the graphical user interface.

13. The method of claim 11, further comprising obtaining one or more material property parameters of one or more individual components of the photopolymer mixture.

14. The method of claim 13, wherein the material property parameters indicate light absorbance characteristics of the individual components of the photopolymer mixture.

15. The method of claim 14, further comprising determining the amounts of the one or more individual pigments of different colors to add to the photopolymer mixture based on the absorbance characteristics of the individual components of the photopolymer mixture and the one or more individual pigments of different colors.

16. The method of claim 11, further comprising dispensing the amounts of one or more individual pigments of different colors into the photopolymer mixture before solidification during additive manufacturing such that the object has the desired color after additive manufacturing.

17. The method of claim 11, wherein the one or more process parameters include a wavelength of ultraviolet light used during the additive manufacturing process.

18. The method of claim 11, wherein the one or more individual pigments of different colors include one or more of a black pigment, a cyan pigment, a yellow pigment, a magenta pigment, a white pigment, a red pigment, a green pigment, or a blue pigment.

19. The method of claim 11, wherein obtaining one or more material property parameters of the photopolymer mixture includes determining one or more material property parameters based on information stored in an external database.

20. The method of claim 11, wherein the color information includes one or more of an RGB color code or a CMYK color code.
